(19) United States
(12) Patent Application Publication
(10) Pub. No.: US 2013/0067013 A1
(43) Pub. Date: Mar. 14, 2013

(54) MESSAGE SYNCHRONIZATION

(71) Applicants: Moshe Dgani, Holon (IL); Moshe Levy, Hod Hasharon (IL); Albert Khavinson, Ramet-Gan (IL)

(72) Inventors: Moshe Dgani, Holon (IL); Moshe Levy, Hod Hasharon (IL); Albert Khavinson, Ramet-Gan (IL)

(73) Assignee: Emoze Ltd, Herzeliya Pituach (IL)

(21) Appl. No.: 13/699,730

(22) PCT Filed: May 22, 2011
(86) PCT No.: PCT/IL11/00399

§ 371 Date: Nov. 25, 2012

Related U.S. Application Data
(60) Provisional application No. 61/347,826, filed on May 25, 2010.

(51) Int. Cl. G06F 15/16

(52) U.S. Cl. 709/206

(57) ABSTRACT

A computerized device, comprising communications facility, a foreground program and a background task configured to launch the foreground program responsive to incoming communication by the communications facility.

### RELATED APPLICATIONS

The present application is a national phase of PCT/IL2011/000399 filed on May 22, 2011, which claims priority from U.S. provisional application No. 61/347,826 filed on May 26, 2010.

### BACKGROUND

The present disclosure generally relates to message handling, and more specifically to message synchronization.

It becomes commonplace for contemporary mobile devices to receive email messages from email servers such as Gmail, Yahoo, MSN and from other email servers of ISPs (Internet Service Provider) or via adapted email applications such as Microsoft Outlook. Generally, when a message is received at the email server, a notification is usually received at the mobile device, notifying that a message has been received at the email server and is available to be transmitted to the mobile device.

Typically, messages are retrieved from the server by an application that operates at the mobile device through communication with the server.

However, there are cases where the mobile device environment supports the execution of only a single application at time. Thus, unless that application can retrieve messages from the server, such as a JAVA mail client application, then the message will not be in synchronization with the portable device.

Examples of computerized environments that are restricted, at least optionally, to running only a single application at a time are Java Virtual Machine (JVM) or Mediatek's MRE (MAUI Runtime Environment).

### SUMMARY

An aspect of some embodiments of the disclosed subject matter relates to apparatus and methods for notifying by communicating with a computerized device about the availability of data intended for the device at data storage but with which the device is not currently connectable. In some embodiments, the computerized device is configured with a task or program responsive to the notification and adapted to launch a program or application connectable with the data storage. In some embodiments, the launched program retrieves or can retrieve the notified data.

Thus, in case the device is not connected with and querying the data storage the device is ignorant about the arrival of new data. However, the ignorance problem is resolved by the notification and optional subsequent retrieval of the new data, as further described below.

In some embodiments, the task responsive to the incoming notification (notification agent) is a background task, responsive to the incoming notification such as by an interrupt evoked by the arriving notification or by polling the state of incoming communications or incoming message.

In some embodiments, the launched program is a foreground task, wherein, in some embodiments, the device is capable to execute only a single foreground program or application at a given moment, for example, a JAVA mail client program. The single application restriction is due, for example, to inherent limitation or setting of the device and/or the configuration thereof and/or software configuration thereof.

In some embodiments, the device is notified about the data by a computerized apparatus, a notification component, connected both with the data storage and the device. The notification component monitors the data storage, such as by periodic queries, for availability of a new data item intended for the device and notifies the device when a new data item is detected.

In some embodiments, the notification component monitors the data storage for data intended for a plurality of devices and notifies the device for which a new data item is detected.

In some embodiments, the data storage is a data server or part of a data server that receives data from other locations and enables data retrieval by apparatus connected therewith.

Thus, in some embodiments, a device that is capable to execute only a single foreground application, such as a mail client application, can still synchronize with newly available data even when the currently executed foreground application is not connected or cannot connect with the data.

In some embodiments, the data is a mail message or messages and the server is a mail server or connected with a mail server.

Accordingly, some embodiments of the disclosed subject matter relate to apparatus and methods for synchronization of messages in a computerized environment that supports the execution of only a single foreground application at a time while the message retrieval application, such as a mail client application, is not the current foreground application.

Thus, in some embodiments, using the notification component and the notification agent—a device that is capable to execute only a single foreground application can still synchronize with newly arrived messages even when the currently executed foreground task, if any, is not a mail client.

Practically, the synchronization provides the device with mail push functionality without having to overload the device, such as by avoiding continuous or periodic communication with the mail server, thereby saving resources. For example, saving battery power, communications bandwidth or processing load. Such resources, in some cases or embodiments, are limited in a portable device relative to desktop or other personal or business devices.

In some embodiments, instead of automatically launching the message retrieval application—a user is given options to launch the message retrieval application or to continue working with the current application.

In some embodiments, the notification component is a server component that is separate from the data mail server and the device, for example, an independent computer. In some embodiments, the notification component is configured as a part of the data or mail server or other data provider, for example, a task running or coupled with the mail server or data provider. In some embodiments, the notification component is configured as a part of the device, optionally when the device has sufficient processing and/or communications and/or power resources. Optionally, the notification component is coupled with and/or constitutes the notification agent. In some embodiments, instead of the notification component sending alert messages to the device, the notification agent communicates with the notification component such as by periodic polling to check if new mail is available.

In some embodiments, the device is a portable device, and optionally the device supports wireless communications.

It is noted that the synchronization may be implemented or carried out using an existing device having processing and communication capability, such as a feature phone, smartphone, computer pad or a notebook computer.

In some embodiments, the implementation comprises the following operations:

Programming the device with a background task responsive to notifications.

Providing and setting a notification component.

Setting the notification component comprises, in some embodiments, notifying or informing the notification component how to recognize data intended for or related with the device. The notification component may be set by the mail server, the device or by another apparatus such as a terminal temporarily connected to the notification component.

In some embodiments, the device employs Java Virtual Machine (JVM) that can execute a single foreground application where the mail retrieval application is, for example, a J2ME application. In some embodiments, the mail retrieval application is, for example, MRE application or a native Email application that supports IMAP (Internet Message Access Protocol) and POP3 protocols.

There is thus provided according to exemplary embodiments of the disclosure a computerized device, comprising:

a communications facility;

a foreground program; and

a background task configured to launch the foreground program responsive to incoming communication by the communications facility.

In some embodiments, the incoming communication comprises a notification message relating to the availability of a new data item intended for the computerized device.

In some embodiments, the incoming communication is provided by a notification server connected between the data provider server and the computerized device, monitoring the data provider server to detect new data items intended for the computerized device.

In some embodiments, the foreground program is a data retrieval program connectable with the data provider server for retrieving data items therefrom.

In some embodiments, the computerized device is a portable computerized device.

In some embodiments, the computerized device is restricted to execute only a single foreground program at a time.

In some embodiments, the single foreground program comprises a mail client program.

There thus provided according to exemplary embodiments of the disclosure a computerized notification component, comprising:

(a) a monitoring communications facility providing commendations with a data provider server;

(b) a notification communications facility providing commendations with at least one computerized device; and

(c) a program operable for monitoring the data provider server to detect a new data item intended for the at least one computerized device and to notify the at least one computerized device about the availability of the new data item.

In some embodiments, the at least one computerized device is a member in a plurality of computerized devices.

In some embodiments, the notification communications facility comprises a wireless communications facility.

In some embodiments, the computerized notification component is comprised in the data provider server.

There thus provided according to exemplary embodiments of the disclosure a system for data synchronization, comprising:

a data provider server;

a computerized device having communications facility and configured with a background task responsive to incoming communication and a foreground data retrieval program connectable with the data provider server for retrieving data therefrom; and

a notification server connected between the data provider server and the computerized device, monitoring the data provider server to detect a new data item intended for the computerized device, and consequent to detection of the new data item intended for the computerized device sends a notification message to the computerized device, wherein responsive to the notification message received by the computerized device the background task launches the foreground data retrieval program.

In some embodiments, the computerized device is restricted to run a single foreground program.

In some embodiments, the single foreground program comprises a mail client program.

In some embodiments, subsequent to launching the foreground data retrieval program the foreground data retrieval program connects with the data provider server to retrieve the item data therefrom.

In some embodiments, the data comprise at least a mail message.

In some embodiments, the computerized device is a portable device.

In some embodiments, the notification server monitors the data provider server to detect a plurality of new data items intended for a plurality of computerized devices, and consequent to detection the new data item intended for a specific computerized device sends the notification message to the specific computerized device

In some embodiments, responsive to a message comprises responsive to an event due to the communication of the message.

In some embodiments, launching the foreground data retrieval program comprises providing a user interface to decide at least one of (i) launch the foreground data retrieval program, (ii) postpone launching the foreground data retrieval program, or (iii) decline to launch the foreground data retrieval program.

In some embodiments, launching the foreground data retrieval program comprises launching the foreground data retrieval program in case the foreground data retrieval program is not running as a foreground application.

In some embodiments, subsequent to the notification message being sent a user of the computerized device is alerted.

In some embodiments, the background task operates according to parameters indicating at least one of (i) whether to enable the background task, (ii) schedule of activation of the background task, (iii) disable the background task on low battery condition, (iv) disable the background task upon roaming to a communication network other than a previous network, or (v) method of alerting a user of the computerized device.

In some embodiments, the notification server operates, at least partly, according to parameters sent from the computerized device.

In some embodiments, the system for data synchronization further comprises synchronization server connected between the computerized device and the data provider server.

In some embodiments, foreground data retrieval program retrieves data from the data provider server via the synchronization server.

In some embodiments, the foreground data retrieval program sends data to the data provider server via the synchronization server.

There is thus provided according to exemplary embodiments of the disclosure a method for data synchronization, comprising:

configuring a computerized device with an agent responsive to data notifications;

detecting a new data item intended for the computerized device or user thereof at a data provider;

notifying the computerized device by a data notification about the new data item; and

launching the data retrieval program by the agent responsively to the data notification.

In some embodiments, detecting comprises monitoring the data provider for new data by an apparatus connected both with the data provider and the computerized device.

In some embodiments, notifying the computerized device comprises sending a message to the computerized device by the apparatus connected both with the data provider and the computerized device.

In some embodiments, subsequent to launching the data retrieval program the data retrieval program communicates with the data provider and retrieves the new data item.

In some embodiments, communicating with the data provider comprises communicating via a synchronization server interfacing between the computerized device and the data provider.

In the context of the present disclosure a background task is as known in the art, such as a program or software module operable continuously or periodically or invokable by an event, for example, an interrupt service routine.

In the context of the present disclosure a foreground application is as known in the art, such as a program or software module operable as a program accessible to a user by a user interface. For example, a JAVA based mail client application.

In some embodiments, the foreground application can retrieve data such as mail from a data provider such as a mail server and in some cases may also send data to the data provider. In some embodiments, the foreground application is a mail client, such as Microsoft Outlook or IMAP or POP, and the data provider is a mail server that stores and/or provides mail messages for clients and dispatches provided mails.

In the context of some embodiments the present disclosure launching a program is beginning or resuming execution of a dormant or otherwise inactive program.

### BRIEF DESCRIPTION OF THE DRAWINGS

Some non-limiting exemplary embodiments of the disclosed subject matter are illustrated in the following drawings.

Identical or duplicate or equivalent or similar structures, elements, or parts that appear in one or more drawings are generally labeled with the same reference numeral, optionally with an additional letter or letters to distinguish between similar objects or variants of objects, and may not be repeatedly labeled and/or described.

Dimensions of components and features shown in the figures are chosen for convenience or clarity of presentation and are not necessarily shown to scale or true perspective. For convenience or clarity, some elements or structures are not shown or shown only partially and/or with different perspective or from different point of views.

FIG. 1 schematically illustrates a computerized architecture for notifying a device that a message intended for the device has arrived at an email server, according to exemplary embodiments of the disclosed subject matter;

FIG. 2 is a flowchart outlining operations for notifying a device that a message intended for the device has arrived at an email server, according to exemplary embodiments of the disclosed subject matter;

FIG. 3 diagrammatically illustrates operations for notifying a device that a message intended for the device has arrived at an email server, according to exemplary embodiments of the disclosed subject matter; and

FIG. 4 shows an example of agent parameters in XML structure, according to exemplary embodiments of the disclosed subject matter.

### DETAILED DESCRIPTION

The following description relates to one or more non-limiting examples of embodiments of the subject matter. The subject matter is not limited by the described embodiments or drawings, and may be practiced in various manners or configurations or variations. The terminology used herein should not be understood as limiting unless otherwise specified.

The disclosed subject matter is described below with reference to flowchart illustrations and/or block diagrams of methods, apparatus (systems) and computer program products according to embodiments of the subject matter. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

Without limiting generality, the description relates to mail messages synchronization between a device and a mail server, yet other mechanisms or elements, such as other data providing and retrieving apparatus or systems or methods, are not precluded.

A general non-limiting overview of practicing the subject matter is presented below. The overview outlines exemplary practice of embodiments of the disclosed subject matter, providing a constructive basis for variant and/or alternative and/or divergent embodiments, some of which are subsequently described.

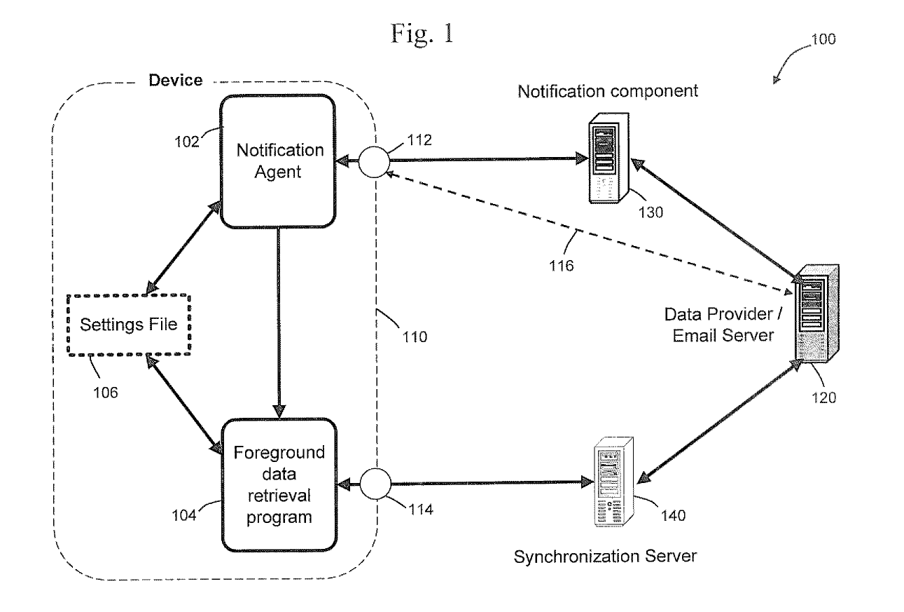

FIG. 1 schematically illustrates a computerized architecture or system 100 for notifying a device that a message or any data item intended for the device has arrived at an email server, according to exemplary embodiments of the disclosed subject matter.

Arrows between components of architecture or system 100 denote control and/or data path between the components as described below.

System 100 generally comprises a device 110, a data provider/mail server 120, and a notification component 130. Notification component 130 may be a separate server. Optionally, or additionally, system 100 comprises a synchronization server 140.

Data provider/mail server 120 is a mail or data server which directly or indirectly receives mail messages or data intended, optionally among other messages, for device 110 or a user thereof. Optionally the data provider/mail server 120 dispatches mails from device 110.

In some embodiments, without limiting, device 110 is a portable device having processing and communications capability (i. e. communications facility). Optionally, the communications is or comprises wireless communications, such as cellular or WiFi. Device 110 is, for example, a smartphone using a chip or chipset that provide processing and wireless communications capability, such as the MTX (Media Tech) chipset.

In some embodiments, device 110 provides a hardware and/or software and/or firmware platform that can run, or set to run, or restricted to run, only a single foreground application while allowing for event driven or repetitive background tasks.

Exemplary software platforms comprise a virtual machine such as Java Virtual Machine (JVM), or an operating system such as Symbian (Symbian Foundation) or Android (Google), or a control kernel or provisions of the underlying hardware. Exemplary foreground applications comprise a J2ME or Java ME application running on JVM, or an IMAP application running as a native application directly on the processor (i.e. not via an interface such as a virtual machine e.g. the RISC processor provided with the MTX chip or chipset.

In some embodiments, device 110 comprises:

a notification port 112, and a synchronization port 114 for notification and synchronization, respectfully, where notification port 112 and synchronization port 114 are communication ports.

a notification agent 102 as a background task responsive to alert messages (e.g. by communication interrupt) from a notification component 130 via the notification port 112.

a foreground data retrieval program 104 connectable via the synchronization port 114 with data provider/mail server 120 and capable to retrieve data messages therefrom and, optionally, send data thereto. In some embodiments, the data comprises or constitute a mail message.

an optional data structure 106 for setting and retrieving operational parameters of device 110.

In the context of the present disclosure a communication port is a structure in device 110 interfacing with incoming and/or outgoing communications, the port formed by hardware and/or firmware and/or software of device 110, for example, as part of the MTX chip or chipset.

The foreground data retrieval program 104 may be, for example, a mail client application, such as mujMail (Free Software Foundation, Inc.) or Mailwithme (COMTOR Ltda.).

The optional data structure 106 may be, for example, a file, a record in a database, or a series of data items or information.

Notification component 130 comprises communications facility or facilities connectable or connected both with device 110 and data provider/mail server 120. In some embodiments, notification component 130 comprises a monitoring communications facility providing communication periodic communications with data provider/mail server 120 and a notification communications facility providing communications with at least one device 110. In some embodiments, notification component 130 comprises a program (and/or other circuitry) operable for monitoring data provider/mail server 120 to detect a new data item intended for at least one device 110 and to notify the at least one device 110 about the availability of the new data item. In some embodiments, the at least one device 110 is a member in a plurality of same or similar devices having notification agent 102 and foreground data retrieval program 104 or equivalents thereof,

In the context of the present disclosure, in some embodiments, a communication facility comprises a modem and/or other circuitry and/or software adapted to receive and/or send communication signals and/or messages. In some embodiments, a communication facility comprises a communication port. i

In the context of the present disclosure, in some embodiments, a communication facility is comprised or is a part of device 110, for example, a communication facility is part of MTX chip or chipset. In some embodiments, a communication facility is adapted or designed for wireless communications such as cellular communications or WiFi.

Independently of device 110, notification component 130 monitors the data provider/mail server 120 by continuously or periodically querying or polling the data provider/mail server 120, checking whether new mails or data items intended for device 110 or a user thereof have arrived at data provider/mail server 120. Once a new mail message is detected, notification component 130 sends an alert to device 110 via notification port 112. The incoming communication or incoming message arriving at notification port 112 invokes the notification agent 102. Notification agent 102 checks if foreground data retrieval program 104 is currently running. If foreground data retrieval program 104 is not running, notification agent 102 halts (pauses) or terminates (exits) the current application if any is currently running. Subsequently, notification agent 102 launches the foreground data retrieval program 104 which connects (or can connect) via synchronization port 114 with data provider/mail server 120 to retrieve the new message as notified and possibly later messages that arrived just after the notification.

In some embodiments, the alert message sent by notification component 130 is a minimal message that is used merely to alert the device 110 for a new message waiting at data provider/mail server 120. For example, the minimal packet of the communications protocol without any data beyond the packet envelope (e.g. header/trailer bits). Optionally, the message is a short one, namely, containing only some minimal information about the waiting message, for example, if the message is flagged as of high importance or the volume of the message or an indication of the account of the mail message (e.g. by a code).

In some exemplary embodiments, once the notification component 130 detected a new massage, then rather than immediately communicating with device 110, the notification component 130 waits for a time period to check whether further messages have arrived. Accordingly, the notification component 130 sends a message to device 110 that contain information about the number of new messages. The waiting period is determined or set without practically decrementing the synchronization between the arriving message and notification of device 110. For example, if a message flagged as high importance the notification component 130 does not wait for possible further messages.

In some embodiments, using minimal or short messages and/or notifying on a plurality of messages, notification component 130 reduces overload on device 110 relative to larger or more frequent messages.

In some embodiments, notification agent 102 checks the information in a notification message (or lack thereof) regarding new message or messages at data provider/mail server 120 and operates correspondingly. For example, notification agent 102 determines to postpone launching of foreground data retrieval program 104 until more messages are available, unless a high importance message is waiting, thereby optionally reducing communications overhead in retrieving the messages. As another example, notification agent 102 determines to postpone launching of foreground data retrieval program 104 until the volume of waiting message or messages reached a set or determined value, thereby optionally reducing processing overhead in retrieving and handling of messages. As yet another example, notification agent 102 determines to postpone launching of foreground data retrieval program 104 until the device 110 determines to send mail (either by another application or foreground data retrieval program 104), thereby optionally reducing processing overhead in handling of messages. Optionally notification agent 102 postpones launching of foreground data retrieval program 104 not beyond a set period or a determined period based on past performance.

In some embodiments, once a notification is received at device 110, notification agent 102 invokes an alert to draw the attention of the device's user. For example, by visual, audible, tactile alerts or the like.

In some embodiments, instead of automatically launching the foreground data retrieval program 104, notification agent 102 provides the user of device 110, such as by pop-up menu, with options to decide or select how to respond to the notification. Exemplary options comprise ‘launch mail client’, ‘do not launch mail client’. Other examples comprise ‘snooze’ such as to postpone the launch for a time period or until another message is notified about, or ‘disable mail client’ directing the notification agent 102 not to launch the foreground data retrieval program 104 nor alert the user of notified mails.

In some embodiments, mail messages of device 110 are retrieved from and/or sent to data provider/mail server 120 via synchronization server 140 that connects with device 110 by synchronization port 114. In some embodiments synchronizer interfaces between device 110 and data provider/mail server 120 providing device 110 access to data provider/mail server 120. For mail retrieval, foreground data retrieval program 104 connects with synchronization server 140 directing the synchronization server 140 to retrieve mails from data provider/mail server 120 or the data source connected thereto (mail provider, such as Gmail, or Yahoo) and send them to device 110. For sending mail, foreground data retrieval program 104 connects with synchronization server 140 providing synchronization server 140 with mails messages to be sent and directing the synchronization server 140 to send the mails to data provider/mail server 120 or destination apparatus connected thereto.

In some embodiments, synchronization server 140 is configured (‘programmed’) with mail accounts details of device 110 or user thereof to enable synchronization server 140 to identify and retrieve mails related to device 110 and to provide data for sending mails from device 110. In some embodiments, synchronization server 140 is programmed by device 110 via synchronization port 114 using an agreed upon data protocol. Optionally or alternatively, synchronization server 140 is preconfigured for mails related to device 110 or user thereof, at least partially such as for a default account.

In some embodiments, device 110 communicates directly through synchronization port 114 with data provider/mail server 120 for retrieving mails and/or sending mails, without or bypassing the synchronization server 140.

In some embodiments, for example when device 110 has sufficient resources such as power, communication band path or processing power or when in idle mode, device 110 queries or polls the data provider/mail server 120 to check and detect arrivals of new mails. In some embodiments the polling is via synchronization server 140, or alternatively, with direct communication with data provider/mail server 120.

In some embodiments, the polling is carried out by a background task (‘polling task’) similar to notification agent 102 but driven by a timer events rather than communication events. Optionally the polling task operates similarly to notification agent 102 such as with regards to launching of foreground data retrieval program 104. Optionally or additionally, notification agent 102 is modified or configured to respond to timer events and operate as a polling task, optionally when notification component 130 is deemed or known to be inactive, e.g. if there is no notification from notification component 130 within a given time.

In some embodiments, polling of data provider/mail server 120 is carried out by foreground data retrieval program 104 running as a foreground application, optionally when notification component 130 and/or notification agent 102 are inactive or disabled.

In some embodiments, device 110 communicates with notification component 130 via the notification port 112 by TCP or HTTP protocols. Optionally, other protocols may be used as agreed between the parties of device 110 and notification component 130.

In some embodiments, device 110 communicates with synchronization server 140 via the synchronization port 114 by HTTP protocol. Optionally, other protocols may be used as agreed between the parties of device 110 and synchronization server 140.

In some embodiments, device 110 communicates with both notification component 130 and synchronization server 140 via the same port, either the notification port 112 or the synchronization port 114. Optionally, a common protocol, such as HTTP, is used for communication with notification component 130 and synchronization server 140 via the same port. Optionally or alternatively, communication with notification component 130 and synchronization server 140 via the same port is by different protocols, for example, FTP protocol for notification component 130 and HTTP protocol for synchronization server 140.

In the description below, reference is made to device 110, notification agent 102, foreground data retrieval program 104, and synchronization server 140 as non-limiting examples.

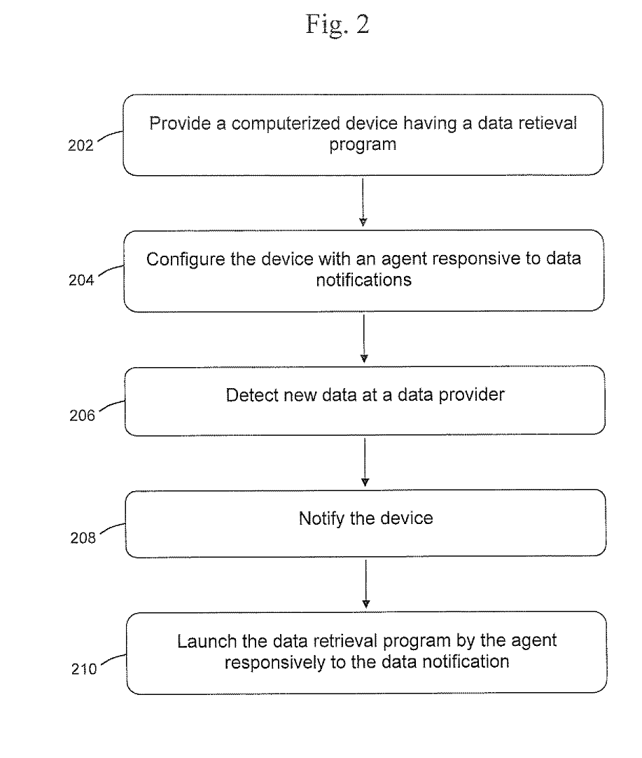

FIG. 2 is a flowchart outlining operations in an exemplary method for notifying device 110 that a message intended for device 110 has arrived at data provider/mail server 120, according to exemplary embodiments of the disclosed subject matter.

In some embodiments, foreground data retrieval program 104 is provided with device 110. Optionally or alternatively, foreground data retrieval program 104 is provided with an add-on or auxiliary component such as smart-card. Optionally or alternatively, foreground data retrieval program 104 is provided by other methods such as by downloading from a remote source.

At 204 the device 110 is configured with notification agent 102 responsive to data notifications by incoming communication to device 110.

Alternatively, in some embodiments, notification agent 102 is provided with the device 110. Optionally or alternatively, notification agent 102 is provided with an add-on or auxiliary component such as smart-card. Optionally or alternatively, notification agent 102 is provided by other methods such as by downloading from a remote source.

At 206 new data intended for device 110, or for a user thereof such as a recipient of a mail message, is detected at data provider/mail server 120.

In some embodiments, the detection is carried out by monitoring the data provider/mail server 120 to check if a new data such as a mail message has arrived. In some embodiments, the monitoring is performed notification component 130. In some embodiments, monitoring is performed by continuously or periodically polling or querying the data provider/mail server 120 whether new data intended for device 110 or user thereof has arrived. In some embodiments, a new data is one or more data items such as one or more mail messages.

At 208 the device 110 is notified that new data is ready at data provider/mail server 120. In some embodiments, upon detecting the new data such as a mail message at data provider/mail server 120 notification component 130 sends to device 110 a data notification, for example, a notification message.

At 210 the notification agent 102 is activated responsive to the data notification and consequently launches foreground data retrieval program 104. Subsequently, in some embodiments, foreground data retrieval program 104 communicates with data provider/mail server 120 and retrieves the notified new data.

It is noted that referring to detection of new data or data item intended for device 110 or user thereof implies, without limiting, cases when no such data is detected and therefore no data notification is sent to device 110,

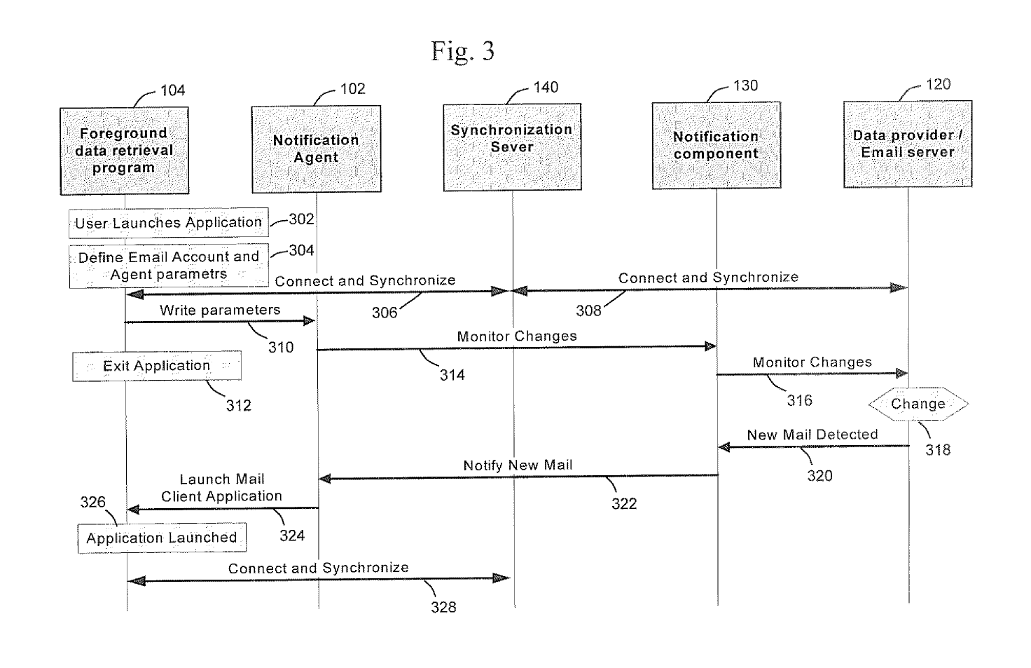

FIG. 3 diagrammatically illustrates operations for notifying device 110 that a message intended for device 110 has arrived at data provider/mail server 120, according to exemplary embodiments of the disclosed subject matter.

At 302 the foreground data retrieval program 104 is launched by a user of device 110. At 304 the required mail account are defined, for example, by user name, password, address (e.g. URL) of incoming mail and outgoing mail and optionally other parameters to such as identification of device 110. Subsequently the relevant details of the mail account are provided to synchronization server 140 and notification component 130 as indicated by arrows 306 and 308, respectively, enabling synchronization server 140 and notification component 130 to recognize and transfer or dispatch mails of the account. In some embodiments, a mail account stands for or represents a plurality of mail accounts.

At 304 the agent operational parameters of notification agent 102 (agent parameters) are also defined with the mail client application. In some embodiments, the agent parameters are defined by a user interface configured in or coupled with foreground data retrieval program 104.

Subsequently, at 310 the account parameters and/or the agent parameters are stored and foreground data retrieval program 104 is terminated or exited. In some embodiments, notification agent 102 reads the agent parameters and operates accordingly. For example, setting operation modes such as active or inactive states, or characteristics such as automatic or manual launching of foreground data retrieval program 104.

Having set the operation mode or characteristics of notification agent 102 by the agent parameters, at 314 notification agent 102 informs notification component 130 to commence monitoring the data provider/mail server 120 for new mail messages. In some embodiments, notification agent 102 informs notification component 130 by a short message similar to the notification messages of notification component 130 described above.

Once started monitoring, notification component 130 communicates with and checks the data provider/mail server 120 whether a new mail message has arrived for device 110, in some embodiments, notification component 130 recognizing mails relevant to device 110 or user thereof by the account details sent before. In some embodiments, the arrival of a new message is reflected in data provider/mail server 120 by a change of the state or status represented as change 318. Change 318 is, for example, a change of the s length of mails list, or status of mails queue, or other structures or mechanisms such flags or semaphores.

Consequent to change 318, at 320 a mail message intended for device 110 is detected in data provider/mail server 120, and at 322 the notification component 130 notifies device 110 that a new mail message is waiting at data provider/mail server 120. Responsively, at 324, notification agent 102 launches foreground data retrieval program 104.

At 326 the foreground data retrieval program 104 is launched and running, and at 328 the data retrieval program 104 connects and synchronizes with synchronization server 140 to retrieve the waiting mails at data provider/mail server 120 and, optionally, to send mails to destinations via data provider/mail server 120. Optionally, in some embodiments, instead of automatically launching the foreground data retrieval program 104, notification agent 102 alerts the user with options how to proceed.

In some embodiments, operational parameters are set for notification agent 102 (‘agent parameters’). Exemplary agent parameters comprise enable/disable the synchronization functionality, scheduling definitions such as days of the week and/or hours in a day in which to operate, type of action such as notification of a user or launching the data retrieval program 104, disabling synchronization on low battery or roaming, various user alert options such as vibration or sound, or mail account or accounts credentials.

In some embodiments, notification component 130 is informed, such as by data sent by communication from device 110, of operational parameters related to notification component 130. For example, schedule of notification component 130, or polling intervals of notification component 130. Optionally, notification component 130 operates, at least partly, according to the parameters sent thereto by device 110. Optionally or additionally, the sent parameters relate to device 110 that sent the parameters. For example, the polling intervals of notification component 130 may differ for each device 110 of a plurality of such devices.

In some embodiments, the parameters related to notification component 130 are stored as part of the agent parameter. Optionally or alternatively, the parameters related to notification component 130 are stored separately of the agent parameters.

In some embodiments, the agent parameters are stored in a memory, such as a non-volatile memory, of device 110. In some embodiments, the agent parameters are stored in a structure such as optional data structure 106. Optionally, the agent parameters are stored on auxiliary or add-on component of device 110, such as a smart card. Optionally or alternatively, the agent parameters are stored remotely from device 110, for example, on computers or data storage of the organization to which device 110 belongs.

In some embodiments, the agent parameters are set via an application of device 110, for example, J2ME application with a user interface configured for setting and storing the agent parameters. In some embodiments, foreground data retrieval program 104 comprises or is adapted with a user for setting and storing the agent parameters. Optionally or alternatively, the agent parameters set remotely, for example, by the organization to which device 110 belongs, and loaded into device 110.

In some embodiments, device 110 is provided with agent parameters stored therein, optionally as fixed (e.g. default) and/or modifiable values.

In some embodiments, notification agent 102 reads (retrieves) the agent parameters, wholly or partly, and operates accordingly (e.g. operation mode).

In some embodiments, notification agent 102 reads the agent parameters upon an event such as activation such as power-on of device 110, or setting or control by a user, or by a remote a indication.

In some embodiments, the agent parameters, at least a part thereof, are set separately or differently for each mail account and notification agent 102 operates differently for notifications of mail of a particular account. For example, notification agent 102 is set to automatically launch the foreground data retrieval program 104 for business account while postponing launching of foreground data retrieval program 104 for a later time.

In some embodiments, agent parameters are stored in XML structure.

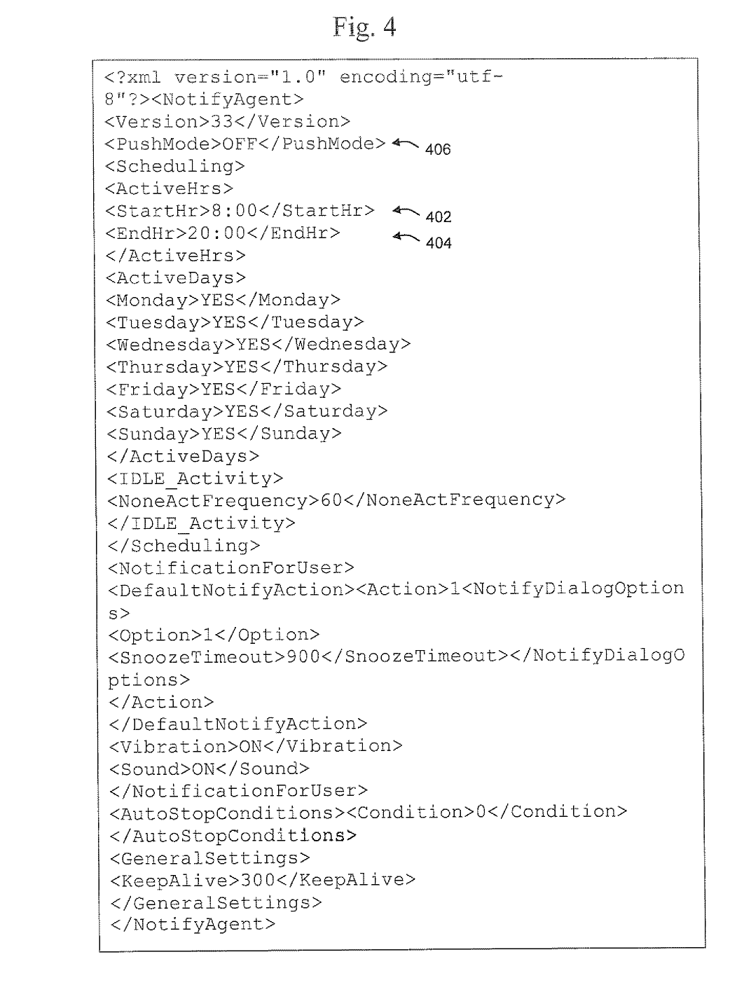

FIG. 4 shows an example of agent parameters in XML structure. Arrows 402 and 404 indicate exemplary XML entries specifying the daily period in which notification agent 102 is supposed to be active, namely, from 8 AM to 8 PM, respectively (unless otherwise disabled, e.g. as indicated by arrow 406)

It is noted that the preemptive, or asynchronous, operation of notification agent 102 that launches the foreground data retrieval program 104 responsive to a mail notification from notification component 130, while halting or terminating whatever other foreground application is running, provides device 110 with mail push or mail synchronization functionality as the launched the foreground data retrieval program 104 can promptly retrieve new mail from data provider/mail server 120. In some embodiments, when notification agent 102 responds to an event such as a communication interrupt, the push or synchronization functionality does not require any resources from device 110 except for the minute context switching. Moreover, in some embodiments, the mail push or synchronization functionality can be active while device 110 is in sleep mode, such as power-saving mode, as notification agent 102 is not running until a notification communication arrives and triggers an event for notification agent 102.

It is further noted that device 110 may still be ignorant of new data available at provider/mail server 120 even when foreground data retrieval program 104 is running on device 110. For example, foreground data retrieval program 104 does not connect with or does not poll data provider/mail server 120, or foreground data retrieval program 104 connects with or polls data provider/mail server 120 sufficiently infrequently to likely miss new data, for example, such as to save power or communication bandwidth. Thus, the preemptive, or asynchronous, operation of notification agent 102 may be used to instruct or indicate to foreground data retrieval program 104 to promptly connect with data provider/mail server 120 to retrieve the new data available at provider/mail server 120. For example, when foreground data retrieval program 104 connects with provider/mail server 120 according to timer events, instructing or indicating to foreground data retrieval program 104 may be carried out by momentarily reducing or nullifying the timer interval or raising a momentary additional timer event.

It is also noted that the detection of new mails in data provider/mail server 120, which may demand continuous polling by data provider/mail server 120, is delegated to notification component 130. In some embodiments, notification component 130 operates on behalf of a plurality of devices such as the device 110 so that one apparatus such as the notification component 130 can provide mail push or synchronization functionality to numerous devices such as the device 110. In some embodiments, notification component 130 operates on behalf of a plurality of devices according to mail account details and/or other parameters provided to notification component 130 from device 110 such as described with respect to operation 304 of FIG. 3, so that notification component 130 operates differently with different devices such as device 110,

In some embodiments, the functionality of notification component 130 is implemented or comprised, at least partially, in data provider/mail server 120 or in a component coupled with data provider/mail server 120. For example, in case data provider/mail server 120 is of an organization to which device 110 belongs then notification component 130 as a separate unit is not required. Accordingly, in some embodiments, as schematically illustrated by line 116 in FIG. 1, device 110 connects directly (or via a proxy) with data provider/mail server 120 such as by notification port 112, where notification agent 102 responds to communication received from data provider/mail server 120.

When not particularly specified, and without limiting, referring to data implies one or more data items such as mail messages, instant messages or any other data items such as alert messages provided by the organization to which device 110 belongs.

It is noted that in the context of the present disclosure, as device 110, as well as notification component 130 and synchronization server 140, are computerized apparatus, referring to configuring or adapting implies programming such as of operations coded and stored on a storage medium or device, or interconnections in an electronic circuit or any technique of the electronics and/or software art.

The flowchart and block diagrams in the Figures illustrate the architecture, functionality, and operation of possible implementations of systems, methods and computer program products according to various embodiments of the present disclosed subject matter. In this regard, each block in the flowchart or block diagrams may represent a module, segment, or portion of program code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the disclosed subject matter. As used herein, the singular forms “a′”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As will be appreciated by one skilled in the art, the disclosed subject matter may be embodied as a system, method or computer program product. Accordingly, the disclosed subject matter may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosed subject matter may take the form of a computer program product embodied in any tangible medium of expression having computer-usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wire line, optical fiber cable, RF, and the like.

Computer program code for carrying out operations of the present disclosed subject matter may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The corresponding structures, materials, acts, and equivalents of all means or step plus function elements in the claims below are intended to include any structure, material, or act for performing the function in combination with other claimed elements as specifically claimed. The description of the present disclosed subject matter has been presented for purposes of illustration and description, but is not intended to be exhaustive or limited to the disclosed subject matter in the form disclosed. Many modifications and variations will be apparent to those of ordinary skill in the art without departing from the scope and spirit of the disclosed subject matter. The embodiment was chosen and described in order to best explain the principles of the disclosed subject matter and the practical application, and to enable others of ordinary skill in the art to understand the disclosed subject matter for various embodiments with various modifications as are suited to the particular use contemplated.

It should be appreciated that the above described methods and apparatus may be varied in many ways, including omitting or adding steps, changing the order of steps and the type of devices used. It should be appreciated that different features may be combined in different ways. In particular, not all the features shown above in a particular embodiment are necessary in every embodiment of the disclosed subject matter. Further combinations of the above features are also considered to be within the scope of some embodiments of the disclosed subject matter.

It will be appreciated by persons skilled in the art that the present disclosed subject matter is not limited to what has been particularly shown and described hereinabove, Rather the scope of the present disclosure is defined only by the claims, which follow.

1. A computerized device, comprising:
communications facility;
a foreground program; and
a background task configured to launch the foreground program responsive to incoming communication by the communications facility.

2. The computerized device according to claim 1, wherein the incoming communication comprises a notification message relating to the availability at a data provider server of a new data item intended for the computerized device.

3. The computerized device according to claim 2, wherein the incoming communication is provided by a notification server connected between the data provider server and the computerized device, monitoring the data provider server to detect new data items intended for the computerized device.

4. The computerized device according to claim 2, wherein the foreground program is a data retrieval program connectable with the data provider server for retrieving data items therefrom.

5. The computerized device according to claim 1, wherein the computerized device is a portable computerized device.

6. The computerized device according to claim 1, wherein the computerized device is restricted to execute only a single foreground program at a time.

7. The computerized device according to claim 6, wherein the single foreground program comprises a mail client program.

8. A computerized notification component, comprising:
(a) a monitoring communications facility providing commendations with a data provider server;
(b) a notification communications facility providing commendations with at least one computerized device; and
(c) a program operable for monitoring the data provider server to detect a new data item intended for the at least one computerized device and to notify the at least one computerized device about the availability of the new data item.

9. The computerized notification component according to claim 8, wherein the at least one computerized device is a member in a plurality of computerized devices.

10. The computerized notification component according to claim 8, wherein the notification communications facility comprises a wireless communications facility.

11. The computerized notification component according to claim 8, wherein the computerized notification component is comprised in the data provider server.

12. A system for data synchronization, comprising:
a data provider server;
a computerized device having communications facility and configured with a background task responsive to incoming communication and a foreground data retrieval program connectable with the data provider server for retrieving data therefrom; and
a notification server connected between the data provider server and the computerized device, monitoring the data provider server to detect a new data item intended for the computerized device, and consequent to detection of the new data item intended for the computerized device sends a notification message to the computerized device, wherein responsive to the notification message received by the computerized device the background task launches the foreground data retrieval program.

13. The system for data synchronization according to claim 12, wherein the computerized device is restricted to run a single foreground program.

14. The system for data synchronization according to claim 13, wherein the single foreground program comprises a mail client program.

15. The system for data synchronization according to claim 12, wherein subsequent to launching the foreground data retrieval program the foreground data retrieval program connects with the data provider server to retrieve the item data therefrom.

16. The system for data synchronization according to claim 12, wherein the data comprise at least a mail message.

17. The system for data synchronization according to claim 12, wherein the computerized device is a portable device.

18. The system for data synchronization according to claim 12, wherein the notification server monitors the data provider server to detect a plurality of new data items intended for a plurality of computerized devices, and consequent to detection the new data item intended for a specific computerized device sends the notification message to the specific computerized device.

19. The system for data synchronization according to claim 12, wherein responsive to a message comprises responsive to an event due to the communication of the message.

20. The system for data synchronization according to claim 12, wherein launching the foreground data retrieval program comprises providing a user interface to decide at least one of (i) launch the foreground data retrieval program, (ii) postpone launching the foreground data retrieval program, or (iii) decline to launch the foreground data retrieval program.

21. The system for data synchronization according to claim 12, wherein launching the foreground data retrieval program comprises launching the foreground data retrieval program in case the foreground data retrieval program is not running as a foreground application.

22. The system for data synchronization according to claim 12, wherein subsequent to the notification message being sent a user of the computerized device is alerted.

23. The system for data synchronization according to claim 12, wherein the background task operates according to parameters indicating at least one of (i) whether to enable the background task, (ii) schedule of activation of the background task, (iii) disable the background task on low battery condition, (iv) disable the background task upon roaming to a communication network other than a previous network, or (v) method of alerting a user of the computerized device.

24. The system for data synchronization according to claim 12, wherein the notification server operates, at least partly, according to parameters sent from the computerized device.

25. The system for data synchronization according to claim 12, further comprising synchronization server connected between the computerized device and the data provider server.

26. The system for data synchronization according to claim 25, wherein the foreground data retrieval program retrieves data from the data provider server via the synchronization server.

27. The system for data synchronization according to claim 25, wherein the foreground data retrieval program sends data to the data provider server via the synchronization server.

28. A method for data synchronization, comprising:
configuring a computerized device with an agent responsive to data notifications;
detecting a new data item intended for the computerized device or user thereof at a data provider;
notifying the computerized device by a data notification about the new data item; and
launching the data retrieval program by the agent responsively to the data notification.

29. The method for data synchronization according to claim 28, wherein detecting comprises monitoring the data provider for new data by an apparatus connected both with the data provider and the computerized device.

30. The method for data synchronization according to claim 29, wherein notifying the computerized device comprises sending a message to the computerized device by the apparatus connected both with the data provider and the computerized device.

31. The method for data synchronization according to claim 28, wherein subsequent to launching the data retrieval program the data retrieval program communicates with the data provider and retrieves the new data item.

32. The method for data synchronization according to claim 31, wherein communicating with the data provider comprises communicating via a synchronization server interfacing between the computerized device and the data provider.
